(19) United States
(12) Patent Application Publication
(10) Pub. No.: US 2019/0044145 A1
(43) Pub. Date: Feb. 7, 2019

(54) RECHARGEABLE COPPER AND SULFUR BASED ELECTRODES FOR ELECTROCHEMICAL APPLICATIONS

(71) Applicant: National Technology & Engineering Solutions of Sandia, LLC, Albuquerque, NM (US)

(72) Inventors: Timothy N. Lambert, Albuquerque, NM (US); Jonathon Duay, Albuquerque, NM (US)

(21) Appl. No.: 16/054,114

(22) Filed: Aug. 3, 2018

Related U.S. Application Data
(63) Continuation-in-part of application No. 15/669,587, filed on Aug. 4, 2017.
Application No. 15/669,587 is a continuation-in-part of application No. PCT/US2017/045629, filed on Aug. 4, 2017.

(51) Int. Cl. H01M 4/58; H01M 10/26; H01M 4/38

(52) U.S. Cl. CPC H01M 4/5815; H01M 2300/0014; H01M 4/38; H01M 10/26

(57) ABSTRACT

A rechargeable electrochemical battery is disclosed. The battery includes a cell container; a cathode comprising a positive electrode active material; an anode comprising a negative electrode active material; a separator disposed between the positive and negative electrodes; and an electrolyte. At least one of the positive electrode active material or the negative electrode active material includes a material including copper and sulfur based compounds that are electrochemically cycled in the rechargeable battery.

### CROSS-REFERENCE TO RELATED APPLICATION

This application claims priority to and is a continuation-in-part of co-pending U.S. patent application Ser. No. 15/669,587, entitled “RECHARGEABLE COPPER OXIDE ELECTRODES FOR ELECTROCHEMICAL APPLICATIONS,” filed Aug. 4, 2017, and to PCT/US2017/045629, entitled “RECHARGEABLE COPPER OXIDE ELECTRODES FOR ELECTROCHEMICAL APPLICATIONS,” filed Aug. 4, 2017, the disclosures of which are incorporated herein by reference in their entireties.

### STATEMENT REGARDING FEDERALLY SPONSORED RESEARCH OR DEVELOPMENT

The United States Government has rights in this invention pursuant to Contract No. DE-NA0003525 between the United State Department of Energy and National Technology & Engineering Solutions of Sandia, LLC, and pursuant to Contract No. DE-AC04-94AL85000 between the United States Department of Energy and Sandia Corporation, for the operation of Sandia National Laboratories.

### FIELD

This application generally relates to rechargeable electrochemical battery cells. This application relates more specifically to rechargeable or secondary batteries having one or more electrodes formed of a material comprising copper (Cu) and sulfur (S) based compounds.

### BACKGROUND OF THE INVENTION

Primary batteries are designed for single time use and discarded upon discharge. In particular, the electrochemical discharge reaction is irreversible, rendering the battery not rechargeable. In a primary battery, the anode provides positive ions to an electrolyte and electrons to an external circuit while discharging. The cathode generally is an electronically conductive material that receives the positive ions from the electrolyte.

Secondary or rechargeable batteries, which will be referred to hereafter as “rechargeable batteries,” are designed to be recharged and reused multiple times. A rechargeable battery utilizes a reaction that is reversible when a current is applied to the battery, with the current “recharging” the battery. The chemical reactions that occur during discharge must be able to be reversed by introduction of the current. When the rechargeable battery is being recharged, the negative active material is oxidized, producing electrons, and the positive material is reduced, consuming electrons. This reintroduction of electrons to the anode by the external current attracts the positive ions back into the anode to restore it to its substantially original composition.

In rechargeable batteries, traditional electrode materials suffer a number of drawbacks. For example, many traditional cathodes, e.g., manganese oxides, lose charge capacity over several charge cycles, are Coulombically inefficient, or possess elevated impedance or internal resistance that negatively affect battery discharge. As these traditional rechargeable batteries progress through charging cycles (“cycling”), battery performance deteriorates.

Copper oxides (e.g., CuO, Cu₂O), hydrates of copper oxide (e.g., Cu(OH)₂), and copper sulfides (e.g., CuS or Cu₂S) have been used as active materials in positive electrodes in primary (non-rechargeable) batteries. Specifically, copper oxides were used in aqueous caustic alkali electrolyte in combination with a zinc anode dating to de Lalande and Chaperon in 1881. However, copper oxide as a cathode material in alkaline batteries has only occurred in primary systems to date.

In certain rechargeable battery technologies, such as Li-ion batteries, copper oxide has been employed as both a cathode and an anode material. However, copper oxides and copper sulfides have not been used in aqueous rechargeable batteries due to substantial limitations. For example, copper oxides are highly soluble in alkaline and acidic electrolytes that results in dissolution of the electrode material that results in rapid capacity fade and sulfides may result in the crossover of sulfur to form insulating ZnS on anodes. As a result, the use of such materials has been limited to primary battery applications.

Attempts at creating an economically desirable rechargeable alkaline battery have typically employed manganese oxides, such as electrolytic manganese oxides, as electrodes. These electrodes suffer from poor cycling at high depths of discharge due to irreversible side reactions such as formation of Mn₃O₄ or ZnMn₂O₄ in cases where paired with Zn anode.

What is needed is a rechargeable electrochemical battery that can overcome the limitations of known rechargeable batteries. Other features and advantages will be made apparent from the present specification. The teachings disclosed extend to those embodiments that fall within the scope of the claims, regardless of whether they accomplish one or more of the aforementioned needs.

### BRIEF SUMMARY OF THE INVENTION

The above objectives are met and the above disadvantages of the prior art are overcome by secondary or rechargeable batteries of the present invention.

The present disclosure is directed to a rechargeable electrochemical battery cell that includes a cell container; an anode including a negative electrode active material; a cathode including a positive electrode active material; and an aqueous solution electrolyte. The positive and/or negative active material includes a copper and sulfur containing material that undergoes oxidation and reduction processes such that it electrochemically cycles to discharge and recharge the battery cell. In an embodiment, the active electrode material may be copper sulfide.

The present disclosure is also directed to a rechargeable electrochemical battery that includes one or more rechargeable electrochemical battery cells.

The present disclosure is also directed to a rechargeable electrochemical battery electrode comprising Cu₂S.

Alternative exemplary embodiments relate to other features and combinations of features as can be generally recited in the claims.

### BRIEF DESCRIPTION OF THE DRAWINGS

The application will become more fully understood from the following detailed description, taken in conjunction with the accompanying figures, wherein like reference numerals refer to like elements, in which:

FIG. 1A shows a schematic for an exemplary secondary battery containing a copper sulfide electrode according to an embodiment of the disclosure.

FIG. 1B shows an exploded view of the exemplary secondary battery of FIG. 1A.

FIG. 2A is a graph demonstrating discharge profiles of a Zn/CuO alkaline cell.

FIG. 2B is a graph demonstrating discharge profiles of a Zn/CuS alkaline cell.

FIG. 2C is a graph demonstrating discharge profiles of a Zn/Cu₂S alkaline cell.

FIG. 3 is a graph demonstrating obtained capacity versus cycle number for the first fifty cycles for the cells producing the discharge profiles at certain cycles shown in FIGS. 2A-2C.

FIG. 4 is a graph demonstrating discharge profiles of Zn/CuO and Zn/Cu₂S alkaline cells with and without electrolyte additives.

FIG. 5 is a graph demonstrating Obtained Energy Density (based on the area and thickness of the electrodes and separators only) versus cycle number for Zn/CuS and Zn/Cu₂S as cycled in alkaline electrolyte at a 0.2 C rate.

FIG. 6A is a graph demonstrating Coulombic efficiency and discharge capacity for Zn/Cu₂S cycled at a 0.2 C rate in alkaline electrolyte.

FIG. 6B is a graph demonstrating Coulombic efficiency and discharge capacity for Zn/Cu₂S cycled at a 2 C rate in alkaline electrolyte.

FIG. 7A is a graph demonstrating volumetric energy density versus cycle number for Zn/Cu₂S batteries cycled at different charge/discharge rates.

FIG. 7B is a graph demonstrating a Ragone plot of volumetric power density versus volumetric energy density for the batteries producing the battery data shown in FIG. 7A.

FIG. 8 is a graph demonstrating areal capacity versus cathode thickness for Zn/Cu₂S batteries.

### DETAILED DESCRIPTION OF THE EXEMPLARY EMBODIMENTS

Before turning to the figures which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting. Unless otherwise indicated, percentages are expressed by weight.

The present disclosure is directed to a rechargeable electrochemical battery cell. The battery cell includes a cell container; an anode including a negative electrode active material; a cathode including a positive electrode active material; a separator disposed between the positive and negative electrodes; and an electrolyte. At least one of the positive or negative active material includes copper and sulfur that electrochemically cycles in the electrolyte to discharge and recharge the battery cell. In an embodiment, the positive and/or negative active material may be copper sulfide. In an embodiment, the electrolyte may be an alkaline aqueous solution.

The present disclosure is also directed to a rechargeable electrochemical battery. The battery includes one or more rechargeable battery cells. Note that the battery would be configured as well understood in the art, for example, two or more cells would include a single battery container that is the cell container for one or more cells. The battery includes a battery container; an anode including a negative electrode active material; a cathode including a positive electrode active material; a separator disposed between the positive and negative electrodes; and an electrolyte. At least one of the positive or negative electrode active material includes copper and sulfur that electrochemically cycles in the electrolyte to discharge and recharge the battery. In an embodiment, the positive or negative active material may be copper sulfide. In an embodiment, the electrolyte may be an alkaline aqueous solution.

The cell and battery operation involves the reduction of the copper and sulfur active material and the re-oxidation of the electrode active material to form a high voltage copper and sulfur based material that recharges the battery. The copper and sulfur based electrode provides excellent stability and energy capacity. The battery can be used in grid storage batteries and in fast discharge (i.e., high power) battery applications. In some embodiments, the copper and sulfur active materials and/or electrolyte may include additives that inhibit the conversion of the copper and sulfur based materials into copper oxides.

In some embodiments, the cell or battery includes a cathode including the active material and the anode can be formed of a negative electrode material including zinc, iron, cadmium, or a metal hydride. In an embodiment, the zinc anode may be a zinc metal anode. In an embodiment, the metal hydride may be a lanthanum nickel hydride (LaN₁₅H_{2.4}) anode.

The separator is electrically insulating but allows for ion conduction between the positive and negative electrodes. The separator may be formed of polymeric materials or be formed as a composite containing additional organic or inorganic species. In certain embodiments, the separator can prevent the transport of the copper ions from one electrode to the other electrode when the active material forms copper ions in the alkaline aqueous solution. In other embodiments, the separator can prevent the transport of the zinc ions from one electrode to the other electrode. In certain embodiments, the separator can prevent the transport of the soluble sulfur based anions from one electrode to the other electrode if the active material forms soluble sulfur based anion in the alkaline aqueous solution.

The electrolyte is an aqueous solution that allows the flow of ions between the anode and cathode. The aqueous solution may be alkaline, neutral or acidic. In various embodiments, the alkaline aqueous solution may be an aqueous potassium, sodium or lithium hydroxide solution. In various embodiments, the alkaline aqueous solution can be an aqueous potassium hydroxide with concentrations ranging from 0.01 to 20 molar (M); an aqueous sodium hydroxide with concentrations ranging from 0.01 to 27 M; or an aqueous lithium hydroxide with concentrations ranging from 0.01 to 12 M; or combinations of aqueous potassium hydroxide, aqueous sodium hydroxide and aqueous lithium hydroxide with concentrations ranging from 0.001 to 20 M with the concentration of lithium hydroxide with the range of 0.01 to 12 M. In some embodiments, the alkaline aqueous solution can be saturated with copper such that no additional copper can be dissolved in the electrolyte. Depending on the exact pH value of the alkaline solution and copper concentrations, copper can exist as soluble hydroxide complexes, such as the tris or tetra hydroxide anion (Cu(OH)₃⁻ or Cu(OH)₄²⁻) or as insoluble copper hydroxides or oxides.

In various embodiments, the aqueous solution may include one or more solution additives that inhibit the conversion of copper and copper based compounds into copper oxides. In an embodiment, the solution additives may be added to alkaline aqueous solutions. In addition, the solution additives can limit the solubility of copper in the alkaline aqueous solution, inhibit the conversion of copper sulfides into copper oxides, bind with copper to form a copper complex, or inhibit the conversion of material comprised of copper and sulfur based compounds from a structure having a high voltage to a structure having a low voltage. The solution additive(s) may be selected from the group consisting of alkali- and alkaline earth -sulfides, alkali- and alkaline earth-selenides, selenium sulfides, tellurium sulfides, bismuth sulfides, bismuth selenides, bismuth tellurides, bismuth pnictides, transition metal sulfides, transition metal selenides, and transition metal tellurides. The solution additives may be present in a 0.5-20 wt % range of the overall electrolyte.

In some embodiments, the alkaline aqueous solution can be saturated with copper between 0.01 and 1 wt %. A saturated copper solution would inhibit the dissolution of copper from either the positive or negative electrode resulting in a longer cycle life for the cell.

In other embodiments, the aqueous solution may be a solvent in salt electrolyte solution. As can be appreciated by one of ordinary skill in the art, the term “solvent in salt” is understood to mean solvents that are miscible with the salt and can dissolve the salt at very high concentrations with mass:volume ratios of salt:solvent inverse to that of a typical salt in solvent solution. For example, aqueous water in salt electrolyte can include salts with concentrations ranging from 1 molal to roughly 21 molal. The solvent may be water, alcohol or another solvent that forms a solution upon mixing.

In an embodiment, the salt is a fluorinated salt. In various embodiments, the fluorinated salt may be amides, imides, and sulfonates salts. In other embodiment, the solution in salt electrolyte solution may additionally contain hydroxide salts such as lithium hydroxide, sodium hydroxide and/or potassium hydroxide. In certain embodiments, the solution in salt aqueous electrolyte may be made alkaline or basic by co-dissolving hydroxide salts. In certain embodiments solvent in salt electrolytes may contain soluble copper by dissolving copper salts into the water in salt electrolyte.

In an embodiment, solvent in salt electrolytes may additionally contain hydroxide salts such as lithium hydroxide, sodium hydroxide and/or potassium hydroxide. The solvent in salt or aqueous water in salt electrolyte may be acidic by containing chemicals or species with acidic functionalities. Examples of such include solvent and water in salt electrolytes containing hydrogen bis(trifluorosulfonyl)imide or other protic acids such as carboxylic acids, sulfonic acids, phosphonic acids. In certain embodiments, the solvent or water in salt aqueous electrolyte may be made alkaline or basic by co-dissolving hydroxide salts. In certain embodiments, solvent in salt electrolytes may contain soluble copper by dissolving copper salts into the water in salt electrolyte.

In other embodiments, the aqueous solution may be neutral. The neutral aqueous solution contains alkali and/or transition metal salts including nitrates, phosphates, carbonates, sulfates, and/or acetates. In an embodiment, the neutral aqueous solution may be copper nitrate, zinc sulfate, and/or sodium acetate.

In other embodiments, the aqueous solution may be acidic. In an embodiment, the acidic solution may be water in salt electrolyte formed by including chemicals or species with acidic functionalities. Examples include water in salt electrolytes containing hydrogen bis(trifluorosulfonyl)imide or other protic acids such as carboxylic acids, sulfonic acids, and phosphonic acids.

Unless otherwise indicated herein, reference to an active material comprised of or including copper and sulfur and/or copper and sulfur based compounds, which will be referred to collectively from hence forth as “copper and sulfur based compounds.” For example, copper and sulfur based materials can include copper sulfides (i.e., CuS or Cu₂S). Additionally, reference to such materials includes mixed metal/copper sulfides, such as iron copper sulfide, silver copper sulfide, or Cu₂₋ₓMₓS mixed metal sulfides in which M refers to another metal. Further, such materials can include materials having copper oxides and/or copper hydroxides and sulfur that form similar species to the above described copper metal hydroxysulfides and copper metal sulfides, for example. The copper to sulfur ratios can range from 100:1 to 2:1. In another embodiment the copper to sulfur ratio may be 1:1, for example, when the copper and sulfur are present in the reactive material as CuS. As understood in this disclosure, ratios are based on atomic or molar ratios.

In various embodiments, copper and sulfur based compounds can include copper metal and elemental sulfur that form similar species to the above-described copper sulfides upon electrochemically cycling. These species enable a high voltage plateau that is not observed with copper oxide materials. High voltage plateaus upon discharge and charge are attributed to the electrochemical cycling between copper(I) polysulfides and copper(I) sulfides, as well as the electrochemical cycling between copper(II) hydroxide and copper(I) hydroxide. Such materials can include materials that include small redox active and/or redox inactive small molecules, including polymers that contain sulfur, such as sulfides, disulfides, and polysulfides. Exemplary materials can include materials that include thiophenol, which is redox active.

In some embodiments, the cathode and/or the anode including the active material can include additives. The electrode additives can include elemental copper, other conductive metals, metal-based additives, or metal salts. The additives may be present in an amount suitable to sustain the high voltage plateaus attributed to the copper sulfide and copper hydroxide species. In an embodiment, the additives may be present in an amount between 1 and 20% by mass. Suitable additives can include aluminum, tin, titanium, chromium, lead, bismuth, cadmium, gallium, mercury, silver, gold, calcium, antimony, zirconium, vanadium, manganese, iron, nickel, cobalt, barium, cadmium, titanium oxide, titanium sulfide, copper selenide, copper telluride, brass or bronze or combinations thereof. These additives can be added to the electrode formulation as a solid or added to an electrolyte in a salt form. In some embodiments, the additives can be used in addition to the carbon materials or as an alternative to the carbon materials. In an embodiment, the additives may be added in an amount between 0.1 and 35 wt. %.

In other embodiments, the electrodes can include bismuth additives in the form of the bismuth additives disclosed in U.S. patent application Ser. No. 15/669,587, entitled “RECHARGEABLE COPPER OXIDE ELECTRODES FOR ELECTROCHEMICAL APPLICATIONS,” filed Aug. 4, 2017, and PCT/US2017/045629, entitled “RECHARGEABLE COPPER OXIDE ELECTRODES FOR ELECTROCHEMICAL APPLICATIONS,” filed Aug. 4, 2017, the disclosures of which are incorporated herein by reference in their entireties. In such embodiments, the bismuth can be added as Bi₂O₃ directly into the electrodes that include a material comprised of copper and sulfur based compounds. Similarly, the electrodes can include sulfur based additives, such as metal sulfides, e.g., bismuth sulfide.

In various embodiments the active material further comprises X % material comprised of copper and sulfur based compounds by weight and Y % electrode additives by weight, wherein X+Y is less than or equal to 98% of the total electrode mass, wherein X and Y do not equal zero, wherein the electrode additive is an additive that inhibits the conversion of the copper sulfide based material into copper oxides, and wherein Y is between 0.1 and 35 wt. %.

In various embodiments, the positive electrode active material and/or negative electrode active material may include conductive carbon and/or a binder. In other embodiments, the positive electrode active material and/or negative electrode active material may not include conductive carbon and a binder. The conductive carbon can be in the form of graphite, carbon nanotubes, graphene, carbon black, activated carbon, and fullerenes. Such exemplary forms of conductive carbon include single walled carbon nanotubes, multi-walled carbon nanotubes, carbon blacks of various surface areas, and others that have specifically very high surface area and conductivity. Other examples of conductive carbon include TIMREX Primary Synthetic Graphite (all types), TIMREX Natural Flake Graphite (all types), TIMREX MB, MK, MX, KC, B, LB Grades (examples, KS15, KS44, KC44, MB15, MB25, MK15, MK25, MK44, MX15, MX25, BNB90, LB family) TIMREX Dispersions; ENASCO 150G, 210G, 250G, 260G, 350G, 150P, 250P; SUPER P, SUPER P Li, carbon black (examples include Ketjenblack EC-300J, Ketjenblack EC-600JD, Ketjenblack EC-600JD powder), acetylene black, carbon nanotubes (single or multi-walled), graphene, graphyne, reduced graphene oxide, and combinations thereof.

The binder can be in the form of teflon, polyvinyl alcohol, polyvinylacetate, polyaniline, polyvinylpyrrolidone, polyvinylidene fluoride, polypyrrole, methyl cellulose, carboxymethyl cellulose, xantham gum, hydroypropyl cellulose, hydropropylmethylcellulose, hydroxyethylmethyl cellulose, carboxymethylhydroxyethyl cellulose, and hydroxyethyl cellulose. In one or more embodiments, the binder can be one or more semiconducting polymers, such as a polymer based on thiophene, ethyleneoxythiophene, anilines, pyrroles, or other similar polymers. In some embodiments, the binder can include sulfur based polymers such as cysteine-based polymers, thiomers, chitosan-cysteine, carboxymethylcellulose-cysteine, polyacrylic acid (PAA)-cysteine, alginate-cysteine, PAA-cysteamine, PAA-homocysteine, or Poly(methacrylic acid)-cysteine.

The disclosure is also directed to methods for producing electrodes. In various embodiments, multiple ingredients are mixed to form a malleable putty. The multiple ingredients include a material comprised of copper and sulfur based compounds, a conductive material and a binder. In an embodiment, the conductive material may be conductive carbon. The malleable putty is processed, e.g., pressed or rolled, into a predetermined electrode shape. The malleable putty is baked or heated for a predetermined time at a predetermined temperature to produce an electrode. Various other methods that include pressing, shaping and forming may be used to form the electrodes.

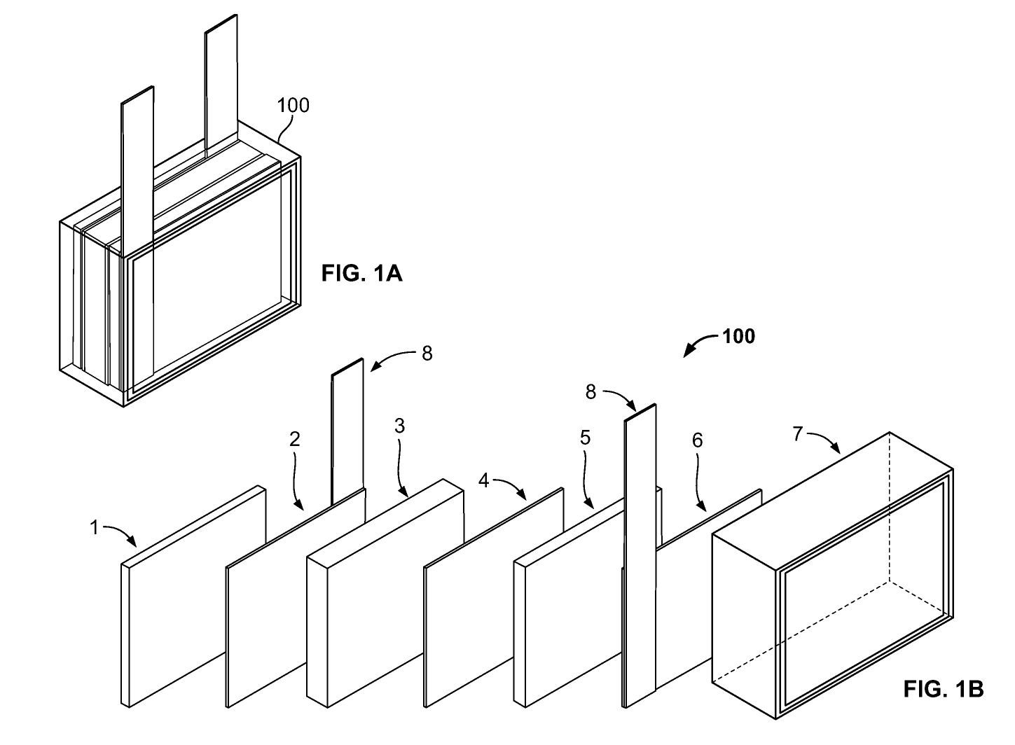

Referring now to FIGS. 1A-1B, a schematic layout of an exemplary rechargeable copper sulfide-based Zn battery cell 100 is shown. A plastic shim 1 is positioned adjacent to a copper mesh current collector 2 in order to provide compression, zinc composite electrode 3 is adjacent to a separator 4, separating the zinc composite electrode 3 from the composite electrode 5, which is coupled with a nickel mesh 6. The battery cell 100 is encased in plastic casing 7, which acts as a cell container. The copper mesh current collector 2 and nickel mesh 6 are both coupled in electrical communication with nickel tabs 8, which act as electrical leads to the battery cell 100. The composite electrode 5 includes a material comprised of copper and sulfur based compounds.

In some embodiments, the current collectors 2 and/or 6 can include nickel or copper. In other embodiments, the current collectors 2 and/or 6 can be carbon-based. The current collector 2 can be in the form of wire, mesh, foil, an ingot, sheet or wire. The separator 4 can prevent crossover of active species between the two electrodes and can allow for the use of different electrolyte compositions on each side of the separator 4. The separator 4 can be wrapped to fully encase one or both of the composite electrodes 3 and 5 and one of the current collectors 2 and 6. In such embodiments, the separator 4 can be wrapped around current collector 2 and composite electrode 3 and/or current collector 6 and composite electrode 5.

In another embodiment, the composite electrode 5 can form copper ions in an aqueous solution, so that the separator 4 can prevent the transport of the copper ions from the composite electrode 5 to the zinc composite electrode 3. In other embodiments, the zinc composite electrode 3 forms zinc ions in the alkaline aqueous solution and the separator prevents the transport of the zinc ions from the zinc composite electrode 3 to the composite electrode 5. In still other embodiments, the material comprised of copper and sulfur based compounds can form soluble sulfur based anion(s) in the alkaline aqueous solution, and the separator can prevent the transport of the soluble sulfur based anion(s) from one electrode to the other electrode.

Disposed within the cell container and in contact with the various components in the battery cell 100 is an electrolyte. In this exemplary embodiment, the electrolyte is 8.5 M KOH. In other embodiments, the electrolyte can be an aqueous potassium hydroxide with concentrations ranging from 0.01 to 20 M. At lower concentrations, precipitation has been observed. At higher concentrations, dissolution of the materials has been observed. In some embodiments, the potassium hydroxide concentrations can range from about 0.5 M to up to a saturation point of about 20 M. In other embodiments, the potassium hydroxide concentrations range from about 1.0 M to about 8.5 M. In other embodiments, the electrolyte may be an aqueous sodium hydroxide with concentrations ranging from 0.01 to 20 M or an aqueous lithium hydroxide with concentrations ranging from 0.01 to 12 molar (M). In some embodiments, the electrolyte can be saturated with copper to prevent the composite electrode 5 from dissolving in the solution.

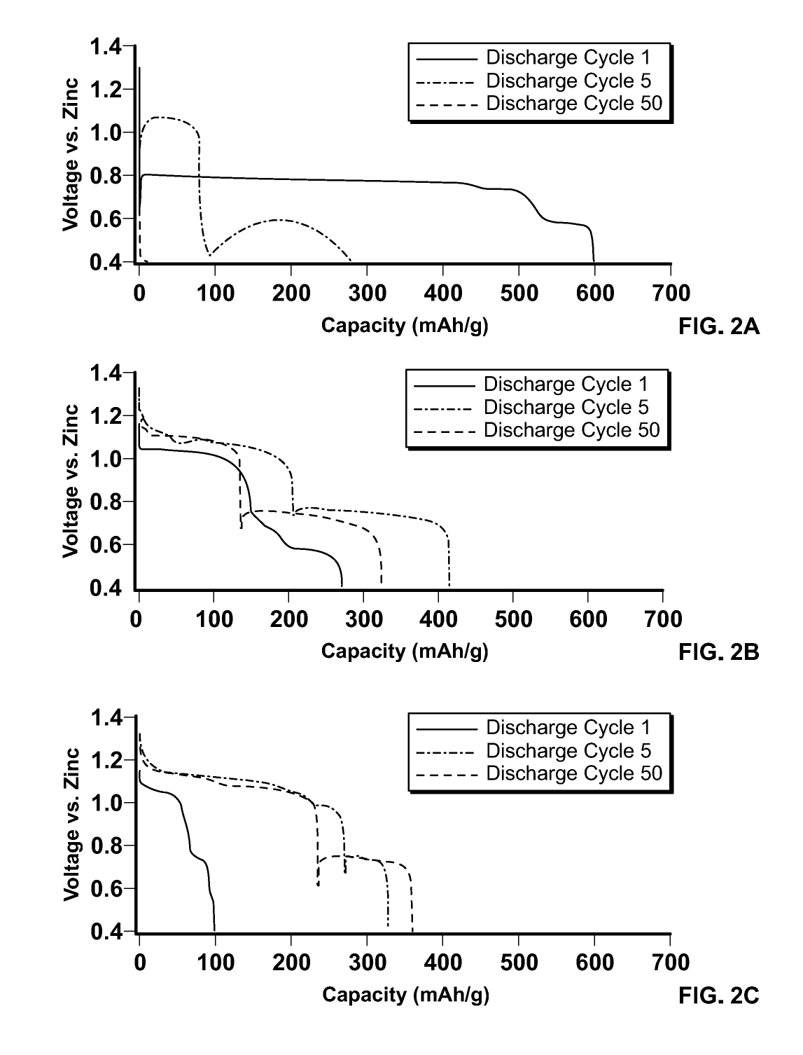

Referring next to FIGS. 2A-2C, discharge profiles of three independent alkaline cells are demonstrated at the 1^{st}, 5^{th}, and 50^{th} cycle. The first example (FIG. 2A) shows the discharge cycles for a conventional Zn/CuO alkaline cell. The second example (FIG. 2B) shows the discharge cycles for a Zn/CuS alkaline cell. The third example (FIG. 2C) shows the discharge cycle for a Zn/Cu₂S alkaline cell. The battery that includes the CuO electrode (FIG. 2A) demonstrates a high initial discharge capacity that approaches a theoretical gravimetric capacity (2 electrons @ 674 mAh/g) at about 0.8 V. The capacity for the conventional battery shown in FIG. 2A quickly fades and fails completely in less than ten cycles.

The batteries that include electrodes formed from a material comprised of copper and sulfur based compounds (FIGS. 2B-2C) exhibit a considerably higher discharge plateau, while being lower in gravimetric capacity. This higher plateau increases in percentage of capacity after the initial first cycle. The batteries also exhibit a second plateau at about 0.8V. The net effect results in rechargeable electrodes and battery systems that have higher or similar volumetric energy densities to batteries with CuO (674 mAh/g) electrodes or even MnO₂ (616 mAh/g) electrodes, even though such materials have higher gravimetric capacities.

The batteries shown in FIGS. 2B-2C both cycle after an initial discharge (i.e., break-in period) that allows for electrochemical discharge and re-charge. Materials characterization techniques, such as x-ray photoelectron spectroscopy, indicate that CuS and Cu₂S both contain copper in a +1 oxidation state indicating at most a 1 electron transfer for copper. Upon cycling or upon exposure to hydroxide, the batteries exhibit greater than 1 electron transfer capacities, which indicates the formation of copper (II) species. Copper (II) species such as CuO (674 mAh/g, calculated for 2e-) are known to have a higher capacity. The degradation of these copper(II) species structure can be inhibited by the presence of sulfur in the materials. Additionally, the S itself may have its own redox behavior contributing to the greater than 1 electron transfer capacities. It is proposed that the sulfur cycling is a major component of the high voltage plateau and overall energy density—copper(I) species are really the desired species but these slowly degrade into copper (II) species. The copper(II) species do continue to cycle whereas one would expect they would not.

It has been established that both sulphur (S) and Cu can dissolve individually at high concentrations in highly alkaline environments with Cu forming Cu(OH)₃⁻ or Cu(OH)₄²⁻ and S forming polysulfide, Sₙ²⁻ (as an example, where n=2, 3, 4, and/or 5), and bisulfide, HS⁻⁻, ions. In the case of alkaline electrolytes, it has been suggested that soluble sulfide is found in the form of the bisulfide ion, HS⁻, with no free S²⁻ ions in solution. High solubility of Cu and S in strong base limits their individual ability to form stable solid-state cathodes in alkaline batteries. However, S and Cu species have a strong affinity for each other and form insoluble copper sulfides/polysulfides when combined in alkaline.

Polysulfides of various atomic chain length are reduced to bisulfide and hydroxide ions in alkaline conditions. These reactions occur at potentials of 0.003 V to 0.298 V vs a standard hydrogen electrode (SHE). Reaction of polysulfides include those depicted in equations 1-4: (1) S₅²⁻+5H₂O+8e⁻↔5HS⁻+5OH⁻ 0.003 V vs. SHE; (2) S₄²⁻+4H₂O+6e⁻↔4HS⁻+4OH⁻ 0.033 V vs. SHE; (3) S₃²⁻+3H₂O+4e⁻↔*3HS⁻+3OH⁻ 0.097 V vs. SHE; (4) S₂²⁻+2H₂O+2e⁻↔2HS⁻+2OH⁻0.298 V vs. SHE.

When polysulfides Sn²⁻(n=2, 3, 4 and/or 5) are combined with a Zn anode, cell voltages ranging from 1.497 V to 1.202 V can be obtained. The gravimetric capacity of polysulfides is high with values ranging from 830 mAh/g to 1340 mAh/g. For example, polysulfide species, Sn²⁻, exhibit capacities and voltages versus Zn of: S₅²⁻ (1340 mAh/g, 1.202 V vs Zn), S₄²⁻ (1256 mAh/g, 1.232 V vs Zn), S₃²⁻ (1117 mAh/g, 1.296 V vs Zn) and S₂²⁻ (838 mAh/g, 1.497 V vs Zn).

The use of copper and sulfur based compounds leads to high capacities due to the ability to cycle between copper sulfides and copper polysulfides, leading to higher voltage and capacities beyond those expected from the Cu+1 oxidation state, that is cycling between Cu+1 oxidation state and Cu metal.

FIGS. 2B-2C demonstrate that materials comprised of copper and sulfur based compounds include copper and sulfur that can form a high voltage, high capacity structure. The high voltage, high capacity structure can degrade into a low voltage, low capacity structure when cycled with an alkaline aqueous solution. The high voltage, high capacity structure can include a copper hydroxide structure and/or copper(I) sulfide based structure. The degradation of the copper hydroxide structure can be inhibited by the presence of sulfur in the materials.

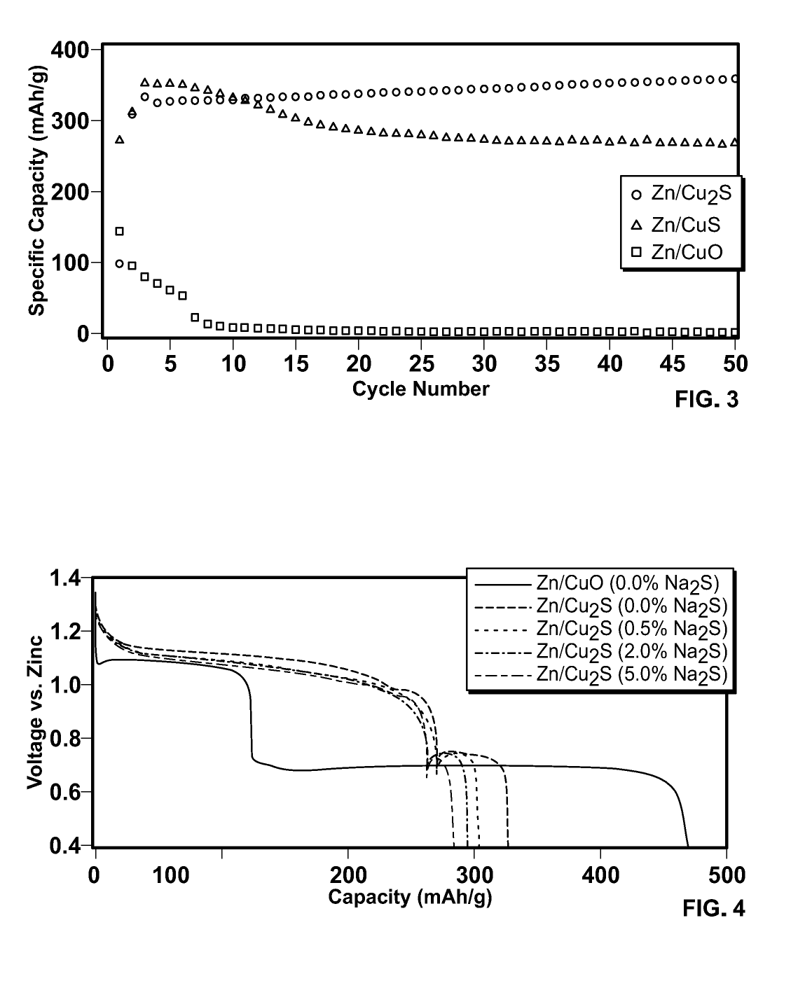

Referring next to FIG. 3, the obtained capacity versus the cycle number for the first fifty cycles for the three batteries shown in FIGS. 2A-2C is shown. The battery with the CuO cathode (FIG. 2A) fails within ten cycles. The battery with the Cu₂S cathode (FIG. 2C) and the battery with the CuS cathode (FIG. 2B) have a sufficient specific capacity after fifty cycles to enable their use in a rechargeable Zn/CuS or Zn/Cu₂S battery.

As shown in FIGS. 2A-2C and FIG. 3, the discharge profiles for the three examples demonstrate that upon cycling the second lower voltage plateau grows in capacity while the higher plateau slowly diminishes for the batteries that include the composite electrodes shown in FIGS. 2B-2C. The second lower voltage plateau in the discharge plots shown in FIGS. 2B-2C is due to the reduction of copper+2 oxides, which are formed slowly of over time upon cycling. These copper+2 oxides are stabilized by the presence of sulfur. In contrast to the battery that includes the CuO electrode (FIG. 2A), the battery that includes the CuS electrode (FIG. 2B) exhibits only a slow decline in capacity. The battery that includes the Cu₂S electrode (FIG. 2C) actually increases in capacity over time.

Referring to FIG. 4, the discharge capacities for various Zn/CuO and Zn/Cu₂S alkaline batteries are shown. The Zn/CuO alkaline battery is essentially identical to the battery shown in FIG. 2A. One of the Zn/Cu₂S alkaline batteries is essentially identical to the battery shown in FIG. 2B. The remaining Zn/Cu₂S alkaline batteries include between about 0.5% and about 5% Na₂S solution additive in the alkaline electrolyte solution. FIG. 4 demonstrates that the additional sulfur in the alkaline electrolyte solution further reduces the second lower voltage plateau.

The Na₂S solution additives and other similar sulfide additives provide a higher cycle life at the higher voltage of the first plateau. Some solution additives can include additives that increase the concentration of copper in the solution or that saturate the solution with copper. Other additives can limit solubility of copper and/or form complexes with copper. Additives may be soluble species in the solution or added to the solid electrode during formulation at which time they may exhibit some solubility.

Suitable sulfide solution additives include selenium sulfide and telluride sulfide. Other suitable solution additives can include sulfite, sulfate, phosphite, phosphate, fluoride, carbonate, triethanolamine, dipicolyamine or other similar amine or alcohol-based molecules and chelators known to bind to copper or coordinate with the copper ion(s). These can be in monomer, oligomer or polymeric form. Similarly, the solution additives can be borate-based compounds, zincate compounds or other -ate complex compounds. Other additives can include bismuth compounds, cadmium compounds, lead compounds, gallium compounds, silicon compounds and/or aluminum compounds, all of which form -ate compounds such as aluminate compounds. These -ate compounds exhibit some solubility at high pH levels.

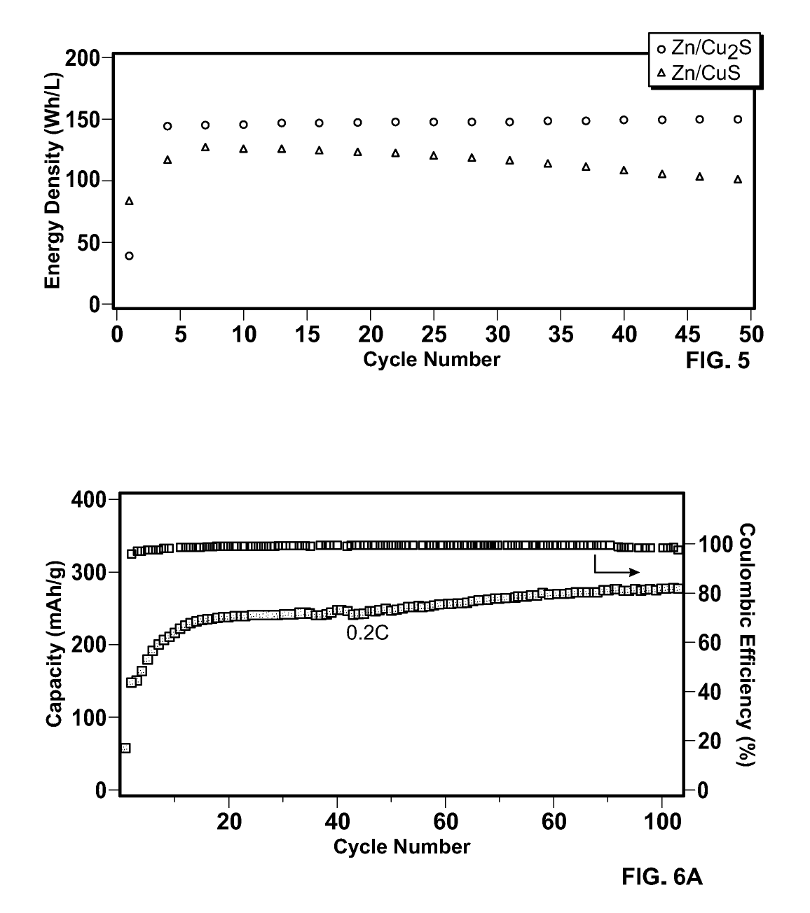

Referring to FIG. 5, this graph shows the obtained energy density (Wh/L), based on the area and thickness of both electrodes as well as the separators, versus the cycle number for Zn/Cu₂S cells and Zn/CuS cells. The graph demonstrates that the cells have a volumetric (materials) energy density of about 150 Wh/L.

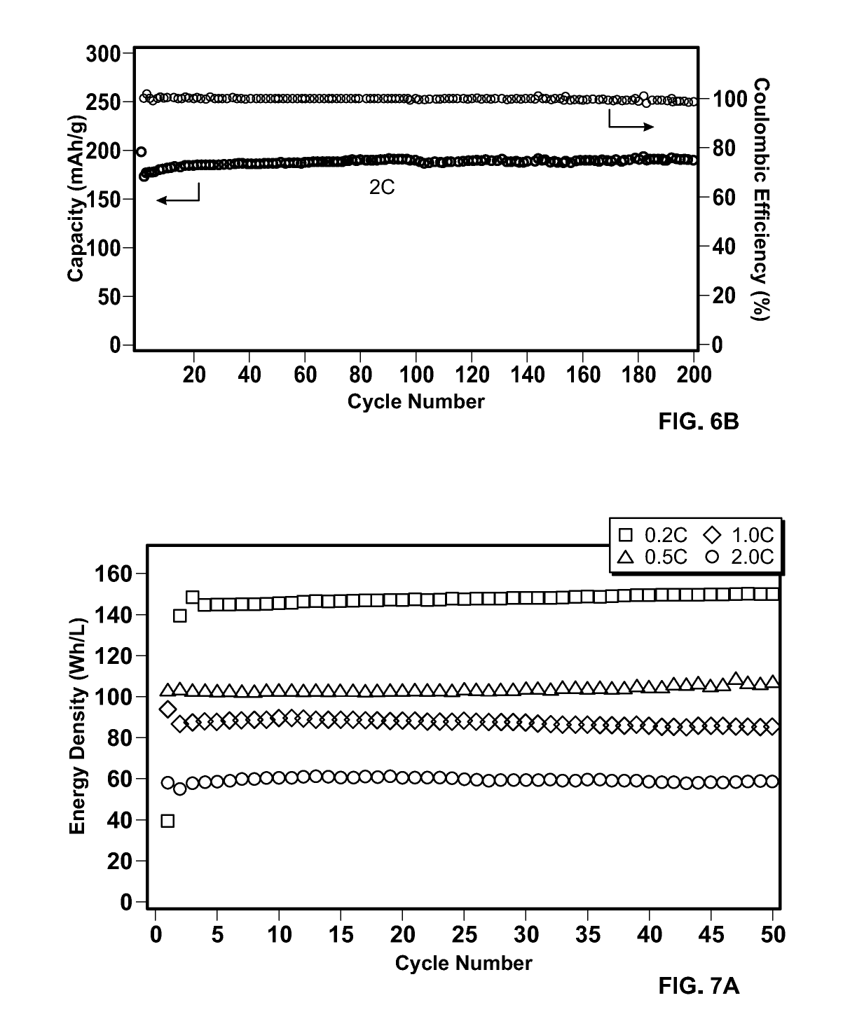

Referring to FIGS. 6A-6B, the Coulombic efficiency and the capacity as a function of cycle number for Zn/Cu₂S cells is shown. FIG. 6A illustrates the Coulombic efficiency and the capacity that is obtained when the cells are cycled at a 0.2 C rate. FIG. 6B illustrates the Coulombic efficiency and the capacity that is obtained when the cells are cycled at a 2 C rate. FIGS. 6A-6B demonstrate that batteries that use such cells can exhibit long cycle life with high columbic efficiencies.

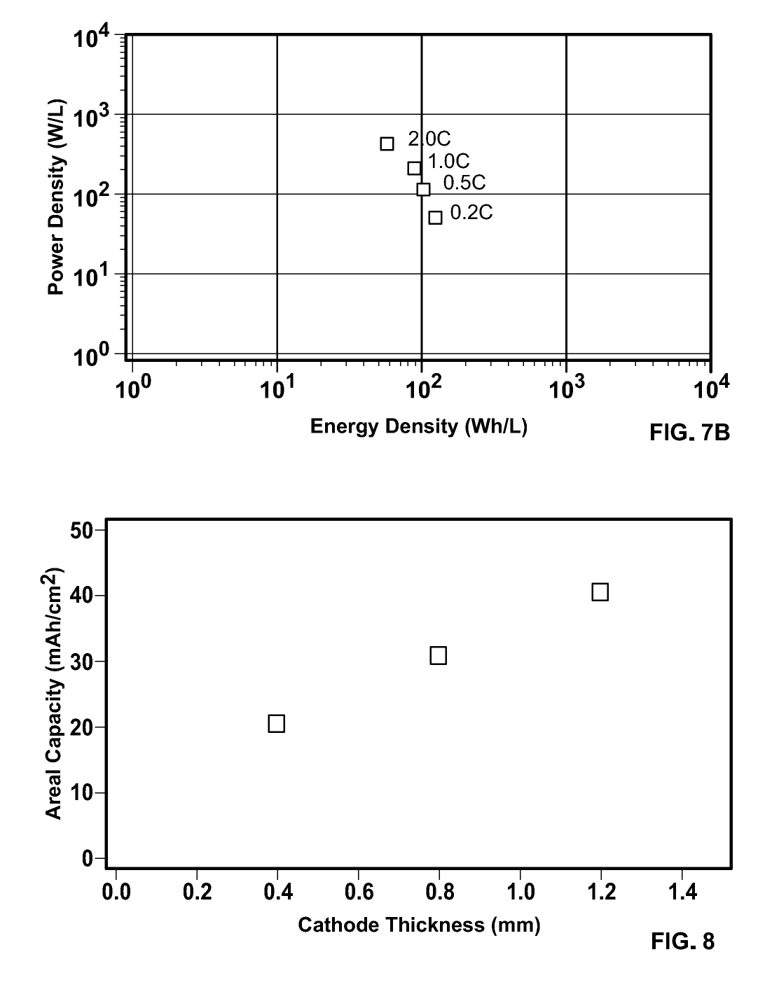

Referring to FIGS. 7A-7B, the rate performance of Zn/Cu₂S cells is shown. FIG. 7A illustrates the cycle ability of the cells at different discharge rates ranging from 0.2 C to 2.0 C. FIG. 7B illustrates a Ragone plot of volumetric power density versus volumetric energy density for the cells at different discharge rates ranging from 0.2 C to 2.0 C.

Referring to FIG. 8, the areal capacity for Zn/Cu₂S batteries as a function of cathode thickness is shown. The cathode thickness ranges from 0.4 mm to 1.2 mm, as measured before compression. FIG. 8 demonstrates that batteries can be scaled in such a way as to obtain large areal capacities.

The electrodes used to develop the data for the above figures were CuO, CuS or Cu₂S composite electrodes that were prepared by combining 65% copper oxide-based materials or copper sulfide-based materials, 30% carbon materials, and 5% binder with a mortar and pestle. In this exemplary embodiment, the carbon materials are graphite powders and the binder is in the form of polytetrafluoroethylene (PTFE) solids. The electrodes can include between about 0.5% to about 10% binder.

In this exemplary embodiment, the copper oxide-based materials/copper sulfide-based materials and graphite powders were mixed thoroughly, and then a PTFE dispersion was added and mixed until uniform. Isopropyl alcohol was then added to produce a malleable putty. The cathode material was rolled out to a thickness of about 0.40 mm, baked at 60° C. for 1 hour, and cut to desired dimensions. One rectangle of cathode material was pressed onto a Ni current collector (Ni gauze spot welded to a Ni tab) at 662 MPa.

In other embodiments, the electrodes may be formed from nanosized (<50 nm diameter) copper oxide-based material particles or copper sulfide-based material particles. In other embodiments, the electrodes may be formed from micron sized (<10 μm diameter) copper oxide-based material particles or copper sulfide-based material particles.

In these exemplary embodiments, the electrodes did not include additives, with the exception of FIG. 4 where Na₂S additive was used in the electrolyte. In other embodiments, the electrodes may include additives that can inhibit the conversion of the material into copper oxides. The additives can be selected from the list of additives discussed above.

In one or more other embodiments, the battery or cell can be built in the discharged state. In such embodiments, one electrode can be made from copper metal and elemental sulfur, initially. The other electrode can be made from ZnO and zinc. The cell could be charged by oxidizing the copper and the sulfur to form a material comprised of copper and sulfur based compounds and reducing the ZnO to form zinc metal. In such embodiments, sulfide compounds, such as titanium sulfide, sodium sulfide, potassium sulfide, lithium sulfide, selenium sulfide, or tellurium sulfide, can be blended with the copper metal in place of or in addition to the elemental sulfur.

An exemplary method for producing an electrode includes mixing multiple ingredients to form a malleable putty. The multiple ingredients can include a material comprised of copper and sulfur based compounds, a conductive carbon, and a binder. The malleable putty can be pressed into a predetermined electrode shape. The malleable putty can be baked for a predetermined time at a predetermined temperature to produce an electrode. Temperature range may be, e.g., 40° C. to 200° C., for time intervals of, e.g., 30 minutes to 120 hours, and at pressures ranging from 500 to 50,000 PSI.

Another exemplary method for producing an electrode includes combining a copper species and a sulfur species in an electrode precursor. The electrode precursor is inserted into a battery or a cell. The electrode precursor rests for a period of time to form a charged electrode.

While the exemplary embodiments illustrated in the figures and described herein are presently preferred, it should be understood that these embodiments are offered by way of example only. Accordingly, the present disclosure is not limited to a particular embodiment, but extends to various modifications that nevertheless fall within the scope of the appended claims. The order or sequence of any processes or method steps can be varied or re-sequenced according to alternative embodiments.

It is important to note that the construction and arrangement of the rechargeable copper sulfide-based electrodes for electrochemical applications as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed can be constructed of multiple parts or elements, the position of elements can be reversed or otherwise varied, and the nature or number of discrete elements or positions can be altered or varied. Accordingly, all such modifications are intended to be included within the scope of the present application. The order or sequence of any process or method steps can be varied or re-sequenced according to alternative embodiments. In the claims, any means-plus-function clause is intended to cover the structures described herein as performing the recited function and not only structural equivalents but also equivalent structures. Other substitutions, modifications, changes and omissions can be made in the design, operating conditions and arrangement of the exemplary embodiments without departing from the scope of the present application.

It should be noted that although the figures herein can show a specific order of method steps, it is understood that the order of these steps can differ from what is depicted.

1. A rechargeable electrochemical battery cell, comprising:
a cell container;
an anode comprising a negative electrode active material;
a cathode comprising a positive electrode active material;
a separator disposed between the anode and cathode; and
an electrolyte disposed in the cell container;
wherein at least one of the positive electrode active material or the negative electrode active material comprises an active material comprising copper and sulfur that electrochemically cycles to provide for the rechargeable electrochemical battery.

2. The rechargeable electrochemical battery of claim 1, wherein the active material comprises a copper and sulfur based compound.

3. The rechargeable electrochemical battery of claim 1, wherein the copper and sulfur based compound is copper sulfide.

4. The rechargeable electrode of claim 2, wherein the copper and sulfur based compound is a mixed metal/copper sulfide.

5. The rechargeable electrochemical battery of claim 1, wherein one or both of the negative and positive active material further comprises a conductive carbon and a binder.

6. The rechargeable electrochemical battery of claim 1, wherein the battery includes one or more additives selected from the group consisting of alkali- and alkaline earth-sulfides, sulfites, sulfates, phosphites, phosphates, fluorides, carbonates, borates, zincates, bismuth compounds, cadmium compounds, lead compounds, gallium compounds, silicon compounds, aluminum compounds, triethanolamine, dipicolyamine alkali- and alkaline earth-selenides, selenium sulfides, tellurium sulfides, bismuth sulfides, bismuth selenides, bismuth tellurides, bismuth pnictides, transition metal sulfides, transition metal selenides, and transition metal tellurides.

7. The rechargeable electrochemical battery of claim 6, wherein the one more additives are present in the electrolyte, the active material or both the electrolyte and active material.

8. The rechargeable electrochemical battery of claim 1, wherein one or both of the positive electrode material and negative electrode material includes one or more additives selected from the group consisting of elemental copper, conductive metals, metal-based additives, and metal salts.

9. The rechargeable electrochemical battery of claim 1, wherein the active material further comprises X % material comprised of copper and sulfur based compounds by weight and Y % of an electrode additive by weight, wherein X+Y is less than or equal to 98%, and wherein the electrode additive is an additive that inhibits the conversion of the copper sulfide based material into copper oxides, and wherein Y is between 0.1 and 35 wt %.

10. The rechargeable electrochemical battery of claim 1, wherein the active material comprised of copper and sulfur based compounds can form copper ions in the alkaline aqueous solution and the separator prevents the transport of the copper ions from one electrode to the other electrode.

11. The rechargeable electrochemical battery of claim 1, wherein at least one of the positive electrode active material or the negative electrode active material further comprises zinc that forms zinc ions in the electrolyte.

12. The rechargeable electrochemical battery of claim 1, wherein the electrolyte is an alkaline aqueous solution.

13. The rechargeable electrochemical battery of claim 1, wherein the electrolyte is a solvent in salt solution.

14. The rechargeable electrochemical battery of claim 13, wherein the solvent is water.

15. The rechargeable electrochemical battery of claim 12, wherein the alkaline aqueous solution is selected from one or more of the group consisting of an aqueous potassium hydroxide with concentrations ranging from 0.01 to 20 M; an aqueous sodium hydroxide with concentrations ranging from 0.01 to 27 M; and an aqueous lithium hydroxide with concentrations ranging from 0.01 to 12 M.

16. The rechargeable electrochemical battery of claim 12, wherein the alkaline aqueous solution includes a solution additive that limits the solubility of copper in the alkaline aqueous solution.

17. The rechargeable electrochemical battery of claim 12, wherein the alkaline aqueous solution includes a solution additive that inhibits the conversion of copper sulfide based material into copper oxides.

18. The rechargeable electrochemical battery of claim 12, wherein the alkaline aqueous solution includes a solution additive that binds with copper to form a copper complex.

19. The rechargeable electrochemical battery of claim 12, wherein the alkaline aqueous solution includes a solution additive that inhibits the conversion of material comprised of copper and sulfur based compounds from a structure having a high voltage to a structure having a low voltage.

20. The rechargeable electrochemical battery of claim 11, wherein the separator prevents the transport of the zinc ions from one electrode to the other electrode.

21. The rechargeable electrochemical battery of claim 12, wherein the alkaline aqueous solution is saturated with copper.

22. A rechargeable electrochemical battery comprising one or more rechargeable electrochemical battery cells of claim 1.

23. A rechargeable electrochemical battery cell, comprising:
a cell container;
an anode comprising a negative electrode active material comprising zinc;
a cathode comprising a positive electrode active material comprising copper sulfide;
a separator disposed between the anode and cathode; and
an alkaline aqueous electrolyte disposed in the cell container.

24. The rechargeable electrochemical battery of claim 23, wherein the electrolyte includes an Na₂S additive.
